(19) United States
(12) Patent Application Publication
(10) Pub. No.: US 2008/0320512 A1
(43) Pub. Date: Dec. 25, 2008

(54) SYSTEMS AND METHODS FOR PROVIDING INTERACTIVE ADVERTISEMENTS THROUGH MEDIA PLAYER SKIN

(75) Inventor: Patrick James Knight, Bournemouth (GB)

Correspondence Address: FENWICK & WEST LLP, SILICON VALLEY CENTER, 801 CALIFORNIA STREET, MOUNTAIN VIEW, CA, 94041, US

(73) Assignee: InSkin Media Ltd., Bristol (GB)

(21) Appl. No.: 12/143,953

(22) Filed: Jun. 23, 2008

Related U.S. Application Data
(60) Provisional application No. 60/945,897, filed on Jun. 22, 2007.

(51) Int. Cl. H04N 7/025

(52) U.S. Cl. 725/32

(57) ABSTRACT

An advertisement delivery technology for advertisers to place advertisements within a frame that wraps around media players embedded in web pages (the media player skin) is disclosed. Advertisers develop advertisements suited to be served into media player skin and avail the advertisements on an online advertisement platform. Video publishers integrate the advertisement delivery technology into their web pages to create media player skins that wrap around embedded video players. When a viewer visits one of these web pages to watch a video clip, the video player is loaded to play the video clip. The media player skin communicates with the online advertisement platform to retrieve an advertisement and places it within the skin. The viewer is exposed to the advertisement while watching the video clip.

### CROSS REFERENCE TO RELATED APPLICATIONS

This application claims the benefit of U.S. Provisional Application No. 60/945,897, “Cost-Per Second Online Video Advertising Platform” by Patrick James Knight filed on Jun. 22, 2007, and which is incorporated by reference herein in its entirety.

### BACKGROUND OF THE INVENTION

1. Field of the Invention

The present invention relates generally to online advertising. In particular, the present invention is directed towards systems and methods for dynamically presenting advertisements within a frame that wraps around a media player.

2. Description of Background Art

There has been a recent boom in websites that host online user generated and professionally created video content. These websites incur huge bandwidth charges as a result of these videos being viewed online by their audience. These websites need to generate revenues from the viewing of these videos to firstly cover the cost of the used bandwidth, and secondly generate revenues, make a profit and fully monetize their online audience.

Online video advertising is a broad term used to describe current solutions available to monetize video that is viewed online. The existing forms of online video advertising are interruptive and not consumer friendly.

One example of these interruptive forms of advertising is in-stream video advertising such as pre-rolls, post-rolls, mid-rolls, and exit links. In-stream advertising is a similar advertising model to the traditional TV commercial advertising model, in that they are interruptions to the consumer experience and force upon the consumer something that they do not request or necessarily want to watch. With little other options, in-stream is proving very popular with advertisers. It is however not a long term solution and will likely follow the decline of TV commercials as consumers get sick of being forced to watch commercials. The website forcing this form of advertising on their audience also runs the risk of damaging their brand and driving consumers elsewhere.

Another example of interruptive form of advertising is in-stream graphical overlay. In this form of advertising, graphic images are overlaid on top of a playing video. This is yet another form of interruptive advertising whereby the consumer experience is altered against their will. A major limitation of this form of advertising is the inability to accurately control where the graphic overlay is placed within the video, and consequently a misplaced graphic could ruin the consumer viewing experience (i.e., the advertising image may overlay a key part of the playing video).

Yet another example of online video advertising is to actually advertise within the online video itself, which happens when advertisers have their products placed within the video itself. This is also known in the industry as “product placement.” The major limitation here is that it is very difficult for the advertiser to accurately measure the effectiveness of their spending. From this perspective product placement is very hit and miss for the advertiser. This form of advertising is also very limited with videos that are user generated (created by consumers rather than professional media production companies). Therefore, generally advertisers can not use product placement effectively with user generated content.

Still another example of the interruptive forms of advertising is banner advertising. This is where an advertiser creates a banner advertisement which gets displayed on the web page that a video is playing on with the hope that the consumer will click on the banner and be taken to an external website. This form of advertising is rapidly on the decline as consumers have been conditioned to ignore banners, and click through rates (when the consumer clicks on the banner) are getting lower and lower.

Thus, there is a need for a non-intrusive and efficient form of advertising for online video publishers.

### SUMMARY OF THE INVENTION

Embodiments of the present invention/disclosure provide an advertisement delivery technology for advertisers to place advertisements within a frame that wraps around media players embedded in web pages (hereinafter called media player skin).

In one aspect, advertisers develop advertisements suited to be served into the media player skin and avail the advertisements on an online advertisement platform. Video publishers integrate the advertisement delivery technology into their web pages to create media player skins that wrap around embedded video players. When a viewer visits one of these web pages to watch a video clip, the video player is loaded to play the video clip. The media player skin communicates with the online advertisement platform to retrieve an advertisement and places it within the skin. The viewer is exposed to the advertisement while watching the video clip. The advertisement can have interactive features that entice the viewer to engage.

In another aspect, the viewer can interact with the advertisement that is served into the media player skin to invoke additional advertisement features. For example, the advertisement can display an overlapping layer with additional information of the advertisement. The media player skin sends a request to the video player to pause the video clip playback when the viewer engages with the overlapping layer, and sends another request to the video player to resume the playback where it left off when the user closes the overlapping layer. As another example, the advertisement can invoke another browser and direct it to an advertisement web page.

In still another aspect, the advertisement displayed in the media player skin can be changed dynamically as the content of the video clip changes. Alternatively, the advertisement can have dynamic components that can be updated as the content of the video clip changes.

Other aspects of the invention include software, systems and components of systems for implementing the advertisement delivery technology described above. Yet additional aspects include methods and applications for all of the foregoing.

### BRIEF DESCRIPTION OF THE DRAWINGS

Figure (FIG.) 1 is a diagram illustrating a computing environment for providing an online advertisement platform.

FIG. 2 is a diagram illustrating a structure of a computer.

FIG. 3 is a diagram illustrating an architecture of an online advertisement server shown in FIG. 1.

FIG. 4 is a flow diagram illustrating a method to serve an InSkin advertisement in a media player skin.

FIGS. 5A-5H are a series of screen shots illustrating a process for a user to view a video clip using a video player wrapped within a media player skin and interact with an InSkin advertisement displayed on the media player skin.

### DETAILED DESCRIPTION OF THE PREFERRED EMBODIMENTS

### Overview

Embodiments of the present disclosure provide methods (and corresponding systems and computer program products) for operating an online advertisement system. The advertisement system places interactive advertisements on frames that wrap around media players. One example of the advertisement system is the InSkin™ Advertisement Platform system provided by InSkin Media Ltd.

The advertisement system provides an advertisement delivery technology (hereinafter called the InSkin Advertisement Delivery Technology) for participating media publishers to integrate into their websites. The InSkin Advertisement Delivery Technology can be applied to existing media players embedded in the publishers' web pages to create (or implant) a frame that wraps around the media players (hereinafter called media player skin or video player skin). Alternatively, the publishers can deploy a media player that has already integrated the InSkin Advertisement Delivery Technology (hereinafter called the InSkin player) in their websites. Participating advertisers provide interactive advertisements designed to be present on the media player skin together with applicable advertisement criteria (or parameters). When viewers visit participating media publishers' websites to access media content, the media player skin serves interactive advertisements around the embedded media player while the player plays the media content. The viewers can interact with the advertisements displayed on the media player skin.

Participating media publishers and advertisers can set their own business model (e.g., cost per impression, cost per click, cost per second) and requirements (e.g., target audience, video category, related keywords). The advertisement system tracks related user activities and provides detailed reports and statistical data to the publishers and the advertisers.

As described herein, media content include any type of media content, such as video, audio, still image, Flash, and game. For purposes of illustration, the methods (and corresponding systems and computer program products) are described in terms of proving advertisements on video player skins of video players embedded in web pages of online video content publishers, even though the disclosed embodiments apply to media players for all other types of media content as defined above.

The methods for operating an advertisement system can be implemented through a server-based computing environment, an example of which is described in detail below with regard to FIG. 1. One skilled in the art would readily understand that the present disclosure is not restricted to this architecture, and can be implemented in other computing environment such as peer-to-peer computing environment.

### Computing Environment

FIG. 1 is a block diagram illustrating a computing environment 100 for providing an online advertisement system 100 according to one embodiment of the present invention. The computing environment 100 includes an online advertisement server (hereinafter referred to as the InSkin Advertisement Platform server or ISAP server) 110, multiple video publishing websites 120, multiple advertiser systems 130, and multiple client devices 140, all communicatively connected through a network 150.

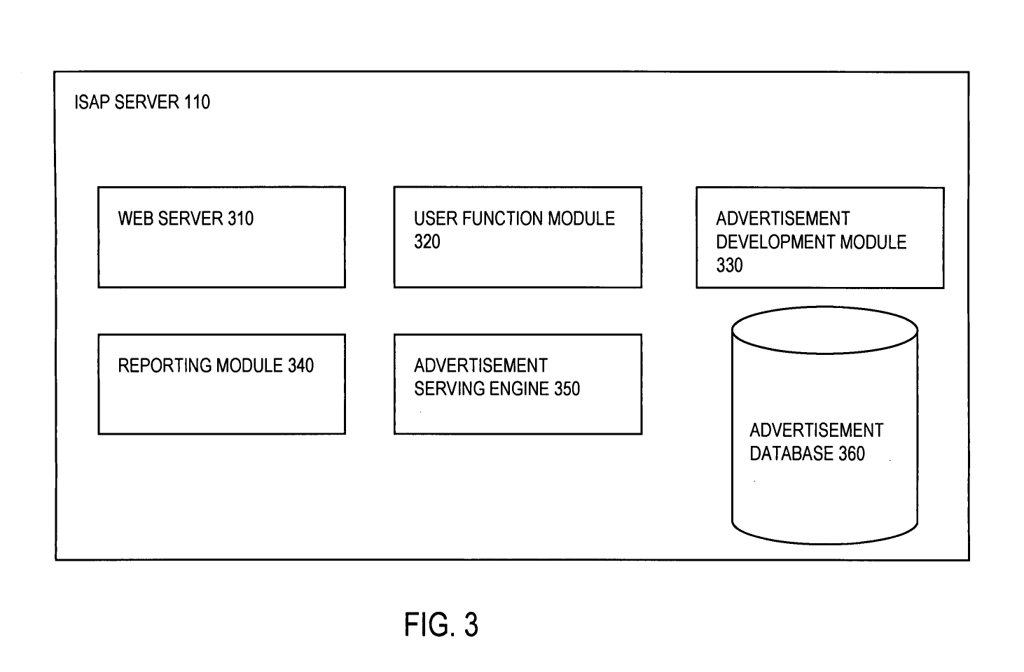

The ISAP server 110 is a hardware and/or software device that provides an online advertisement platform for advertisers to integrate interactive advertisements into video player skin as displayed on web pages. The ISAP server 110 also enables advertisers to create interactive advertisements suited for integrating into video player skin (hereinafter called InSkin advertisements) and manage advertising campaigns. In addition, the ISAP server 110 enables video publishers to integrate the InSkin Advertisement Delivery Technology into their websites to create video player skins that wrap around embedded video players, and accept and display InSkin advertisements on their websites when viewers access their videos. A detailed example architecture of the ISAP server 110 is described in detail below with respect to FIG. 3.

A video publishing website 120 is a hardware and/or software device that provides video to its viewers. The video publishing website 120 can be an online video marketplace such as YouTube™ or an online video hosting website. In one embodiment, the video publishing website 120 includes a web server that hosts or generates web pages including video clips and embedded video players enabling viewers to watch the included video clips.

An advertiser system 130 is a hardware and/or software device that provides advertisements. The advertiser system 130 can host video advertisements that can be placed before a video clip (hereinafter called pre-roll) or after (post-roll). The advertiser system 130 can also host InSkin advertisements and web pages designed for various advertising campaigns.

A client device 140 is a hardware and/or software device for viewers to request, retrieve, and view video from the video publishing websites 120 through the network 150. Examples of the client device 140 include a personal computer (laptop or desktop), a mobile phone, a personal digital assistant (PDA), and other mobile computing devices. The client device 140 can have one or more operating systems such as Microsoft Windows, LINUX, and/or a variant of UNIX. In one embodiment, the client device 140 includes a browser application (e.g., Palm Blazer™, Opera mobile browser, Microsoft Internet Explorer™, Mozilla Firefox™, or Apple Safari™) for viewers to access the web pages retrieved from the video publishing websites 120 and utilize the embedded video player to play the requested video while exposed to the InSkin advertisement displayed on the video player skin.

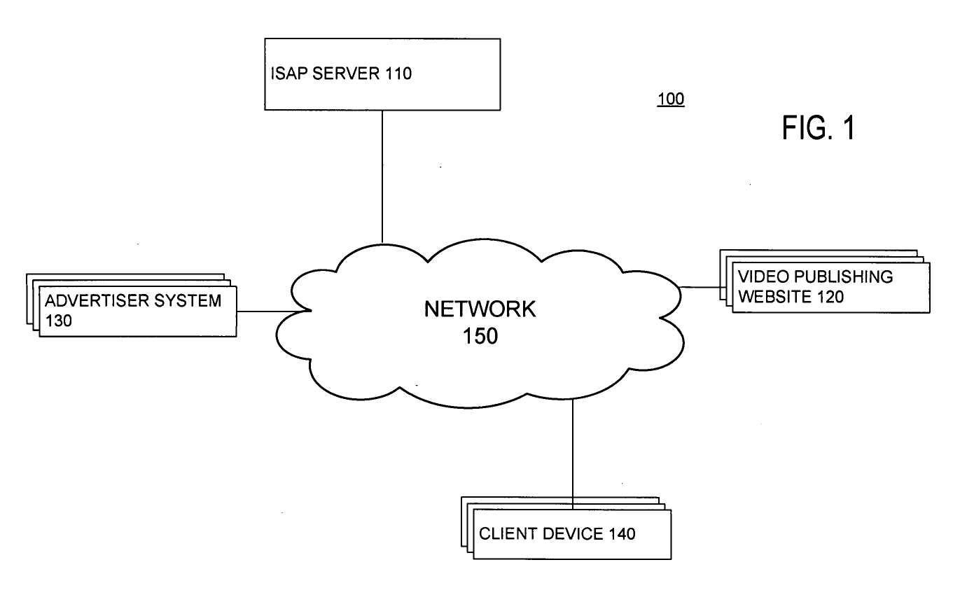

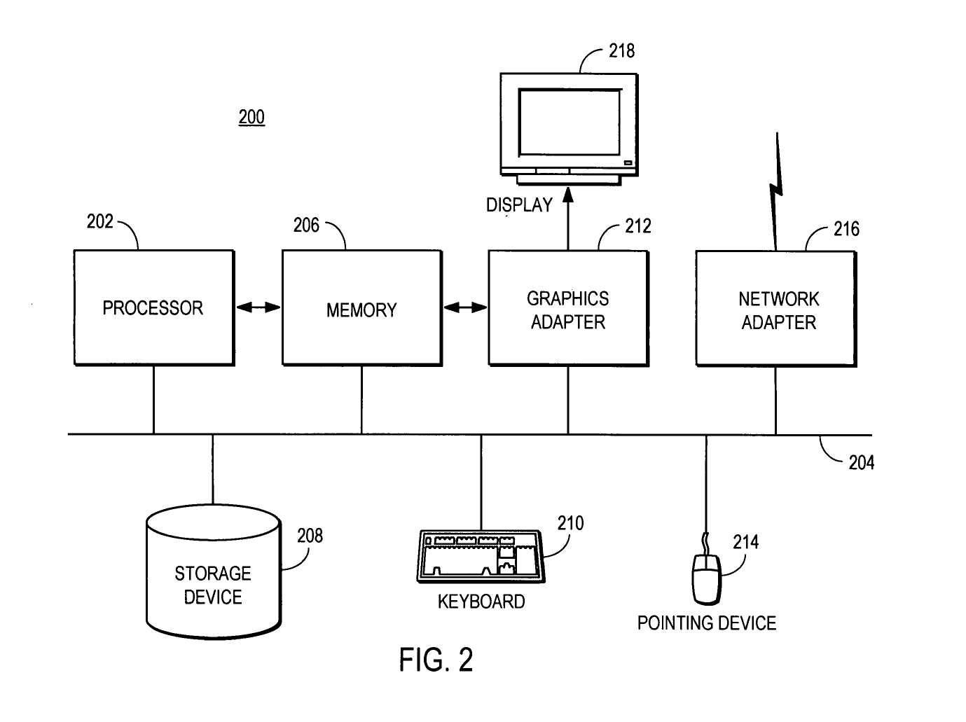

The ISAP server 110, the video publishing websites 120, the advertiser systems 130, and the client devices 140 may be stored and operated on a computer 200 as illustrated in FIG. 2 according to one embodiment. Referring to FIG. 2, the computer 200 includes at least one processor 202 coupled to a bus 204. Also coupled to the bus 204 are a memory 206, a storage device 208, a keyboard 210, a graphics adapter 212, a pointing device 214, and a network adapter 216. A display 218 is coupled to the graphics adapter 212.

Referring back to FIG. 1, the network 150 is configured to connect the ISAP server 110, the video publishing websites 120, the advertiser systems 130, and the client devices 140. The network 150 may be a wired or wireless network. Examples of the network 150 include the Internet, an intranet, a WiFi network, a WiMAX network, a mobile telephone network, or a combination thereof.

### System Architecture for the ISAP Server

FIG. 3 is a high-level block diagram illustrating modules within the ISAP server 110 in FIG. 1 according to one embodiment. Those of skill in the art will recognize that other embodiments can have different and/or additional modules than those shown in FIG. 3. Likewise, the functionalities can be distributed among the modules in a manner different than described herein. Further, some of the functions can be provided by entities other than the ISAP server 110. As illustrated, the ISAP server 110 includes a web server 310, a user function module 320, an advertisement development module 330, a reporting module 340, an advertisement serving engine 350, and an advertisement database 360. The modules can be implemented using technologies such as Microsoft™ ASP .NET.

The web server 310 is a front end of the ISAP server 110 and functions as a communication gateway into and out of the ISAP server 110. In one example, the web server 310 provides an online advertisement platform website with web pages enabling advertisers to integrate interactive advertisements into video player skins, and video publishers to integrate the InSkin Advertisement Delivery Technology in their websites and display InSkin advertisements on their web pages.

The user function module 320 is designed to provide tools for participants of the online advertisement platform to engage in online video advertising. The user function module 320 provides general functions such as account setup and account management. In addition, the user function module 320 provides specific functions to participants depending on their roles. For example, advertisers can create and manage advertising campaigns through the user function module 320, and video publishers can integrate the InSkin Advertisement Delivery Technology in their websites through the user function module 320.

The advertisement development module 330 is designed to provide advertisers with tools to develop customized interactive video player skins. The customized interactive video player skins function as interactive advertisements. The customized interactive video player skin and the InSkin advertisement are used interchangeably in the following description. Advertisers can create, edit, and manage their customized interactive video player skins through the advertisement development module 330.

The reporting module 340 is designed to interact with the advertisement database 360 to generate reports to participants. The reports contain data related to the participants' accounts. Depending on participants' need, the reporting module 340 can generate reports containing statistical data of different levels of detail or granularity. For example, reports for advertisers may contain information such as the click through rate (CTR) of a specific advertising campaign or a specific InSkin advertisement.

The advertisement serving engine 350 is designed to identify a relevant InSkin advertisement based on video requested or provided to viewers, and to serve the identified InSkin advertisement in the media player skin wrapped around the requested video. The advertisement serving engine 350 selects InSkin advertisements based on advertisement criteria provided by advertisers and/or content criteria set by the video publisher.

The advertisement database 360 is designed to store InSkin advertisements and all information related to participants. In one embodiment, customized interactive video player skins developed though the advertisement development module 330 are stored in the advertisement database 360. The advertisement database 360 may be a relational database or any other type of database that stores the data, such as a flat file.

### System Operation for the ISAP Server

The ISAP server 110 enables advertisers to display advertisements on video player skin deployed on video publishers' websites such that when viewers view video hosted on these websites, they are exposed to advertisements displayed on the video player skin.

There are a variety of participants for the video advertisement platform. These participants include video publishers (or providers, owners, hosts), advertisers, media buyers (or brokers), InSkin advertisement designers. Each participant may have different privileges based on available features or functionalities. A participant may also play several different roles. For example, a media buyer may also be an advertiser and an InSkin advertisement designer.

A participant can visit the online advertisement platform website to set up an account by specifying his role(s) and related information (e.g., name, address, bank account, etc.). The ISAP server 110 sets up an account for the participant and allocates privileges based on his role(s). A participant can subsequently modify his role and profile.

After opening an account, an advertiser can create and manage advertising campaigns by providing related information (e.g., targeted audience, their age, geographic area, budget, duration, etc.). An advertiser can also manage advertisement criteria, criteria that a website must meet in order for an advertisement (or advertising campaign) to be displayed in the website. Examples of such criteria include website language, target audience, fee requirement, and time zone. The advertiser can also create and manage InSkin advertisements (assuming he is also an InSkin advertisement designer) and view his reports and relevant statistics. An advertiser can specify the target website(s) for his advertisements or advertising campaigns and related target parameters (e.g., starting and end date, target impressions, and budget). If the advertisement (or advertising campaign) is subject to publisher approval before it goes live on the website, the advertiser must submit it for approval to the publisher.

A video publisher can deploy (or integrate) the InSkin Advertisement Delivery Technology in some or all of his websites. For each website, he can choose to integrate the InSkin Advertisement Delivery Technology into some web pages and not others (a.k.a., site selection, site section, sub-domain). A video publisher can choose to either integrate the InSkin Advertisement Delivery Technology into existing embedded video players or embed a video player that has already integrated the InSkin Advertisement Delivery Technology (InSkin player) in his web pages. A video player with integrated InSkin Advertisement Delivery Technology and the InSkin player are both called an InSkin enabled video player. The video publisher can setup and modify his settings. In order to integrate the InSkin Advertisement Delivery Technology in a website, the video publisher is required to provide information about the website (e.g., name, description, URL, time zone, category, language, whether pre-roll is allowed). The video publisher can also set and edit content criteria, criteria that an InSkin advertisement must meet in order to be displayed on his websites. For example, he can specify a advertisement fee model (e.g., cost per impression, cost per second, cost per click, etc.) that advertisers will pay for exposure of their advertisements on his websites. The video publisher can also specify criteria for allowed advertisements (e.g., no adult-only content, no pre-roll or post-roll). In one implementation, the video publisher can require his pre-approval before an InSkin advertisement (or advertising campaign) can go live on his websites.

A media buyer can have the same privileges as an advertiser. In addition, a media buyer may manage several advertisers (e.g., add or remove advertisers, accessing advertisers' reports). An InSkin advertisement designer can create, edit, and manage InSkin advertisements.

When a viewer visits a participating video publisher's website to view a video clip, the website returns a web page with an InSkin enabled video player embedded within. The video clip is played by the InSkin enabled video player wrapped within a video player skin. Depending on the publisher and the video, the ISAP server 110 (e.g., the advertisement serving engine 350) identifies an InSkin advertisement and displays it in the video player skin. The InSkin enabled video player provides the common video control functions (e.g., Play, Pause, Stop, Forward, etc.) to the viewer. The displayed InSkin advertisement presents interactive feature(s) that the viewer can interact with to invoke additional features of the advertisement.

The video player skin (or the InSkin Advertisement Delivery Technology) tracks user actions (or lack of actions) while the viewer is exposed to InSkin advertisements, and transmits this information back to the ISAP server 110. The ISAP server 110 processes this information (e.g., calculating incurred advertisement costs and transferring payments from advertiser's account to video owner's account accordingly) and stores for later uses (e.g., in the advertisement database 360).

The ISAP server 110 also provides reports to participants. The ISAP server 110 can periodically (or upon demand) retrieve relevant data and generate reports and statistical data for participants to review. For example, an advertiser can receive a monthly report summarizing the performance of his advertising campaigns and return on investment (ROI) data. As another example, a video publisher can request statistical data regarding advertisement revenue generated by one of his websites. The report generated for an advertising campaign may include information about websites (or site sections) the campaign was placed in, advertisements in the campaign, and performance data such as served impressions (e.g., the number of times an advertisement was viewed), interaction rate (e.g., user-initiated interactions divided by served impressions), and click through rate (e.g., the frequency of click-throughs as a percentage of served impressions).

In one implementation, the ISAP server 110 tracks the real time exposure of InSkin advertisements. The InSkin player transmits real-time tracking information to the ISAP server 110. The reporting module 340 in turn generates reports and statistical data reflecting real-time performance of websites and advertising campaigns. In addition, participants can drill down the statistical data to obtain real-time performance data of preferred granularity.

### InSkin Player and Video Player Skin

An InSkin enabled video player is a video player application that has the InSkin Advertisement Delivery Technology integrated within, and that can be embedded in web pages, such that viewers of such web pages can play video without leaving the web page. The InSkin enabled video player provides basic video player functions such as Play, Pause, and Stop. The InSkin Advertisement Delivery Technology can be integrated to any type of video player including those that support a wide range of video formats, such as Windows Media, Flash Video (FLV), SilverLight, Real Video, QuickTime, and MP4. Examples of such video players include Windows Media Player, Real Player, FLV Player, Silverlight Player, QuickTime Player, Syndicated Players (e.g., Brightcove, ROO, Ooyala, and Kewego), and embeddable players such as YouTube, Metacafe, Blinkx, Revver, and Dailymotion. An InSkin player is a media player that is pre-enabled with the InSkin Advertisement Delivery Technology. For clarity, the following discussion is about the InSkin player, even though the same principle applies to InSkin enabled video players.

The InSkin player is designed to display a video player skin. The video player skin is a frame area surrounding the played video (hereinafter called InSkin player frame) and serves as a placeholder to display InSkin advertisements. The InSkin player frame can have borders with adjustable width to provide necessary real estate for advertisers to place advertising information. The video player skin can include one or more interactive features related to the advertisement.

For example, a viewer can click (or mouse over) the video player skin (e.g., the portion around the played video). As a result, the InSkin player pauses the underlying video. The video player skin displays additional advertising information on an overlapping page that the viewer can interact with. For clarity, the video player skin wrapped around the played video is referred to as the skin layer (or layer 1) and the overlapping page is referred to as the expandable landing page layer (or expansion layer, layer 2). The expandable landing page layer can be of any size depending on the advertiser's need. For example, the expandable landing page layer can be larger than the InSkin player, and cover the entire user screen. Advertisers can utilize the expandable landing page layer to capture user data, enable mobile downloads, and provide contents such as sweepstakes, games, and rich media.

Alternatively or in conjunction, responding to the click, the video player skin can lead the browser to the corresponding advertiser's web page designated for the advertising campaign. The video player skin can also enable viewers to expand the InSkin player to a full-screen mode. During full screen mode, the InSkin advertisement served in the video player skin is still visible to the viewer, and the viewer can still engage with the InSkin advertisement. The video player skin can also have other media component such as animation and background music accompanying the advertisement.

These features can enable advertisers to create attractive advertisements. For example, an advertiser plans to create an InSkin advertisement for a video game launch to promote awareness of the game. The advertiser can design the InSkin advertisement in the following manner. The customized video player skin can contain (or place) information about the game, such as the game title, release date, and major scenes. The information can be designed as animation or interactive controls such that a viewer can interact with them and an expanded layer will be displayed. The expanded layer can contain information such as a full 2.5 minutes video trailer, entries to sweepstake, promotions to related contents, and links to related Facebook and/or Myspace pages. When a viewer watches a video in the InSkin player displaying the InSkin advertisement, the advertisement wraps around the InSkin player and creates continuous brand awareness for the duration of the video. Interested viewers can click on the InSkin advertisement at any time to reveal the expandable landing page. The advertiser can also create an accompanying pre-roll for a brief preview of the video game accompanying the InSkin advertisement.

The InSkin advertisement displayed around the InSkin player embedded in a web page (or site selection or website) can be set statically. For example, the video publisher (or the advertiser) can specifically set a customized video player skin (InSkin advertisement) to be served in the video player skin for a specific video (or a set of videos or a website). Thereafter, when a viewer views the video at the video publisher's website, the customized interactive video player skin will be shown to the viewer.

The InSkin advertisement can also be dynamically selected. For example, when a video is launched in the InSkin player and there is no statically set InSkin advertisement, the advertisement serving engine 350 can select an InSkin advertisement for the InSkin player on the fly. The advertisement serving engine 350 can make the selection based on criteria and/or target parameters associated with InSkin advertisements and content criteria associated with the video (or publisher, website, site selection). For example, the advertisement serving engine 350 can select the advertisement that matches the best with a subject of the video and/or provides the most revenue for the video publisher.

The InSkin advertisement can be dynamically configured. A customized interactive video player skin can be a template with specific elements that can be changed dynamically in real time (e.g., when the context of the underlying video chances). The dynamic elements can span both layers of an InSkin advertisement. For example, an InSkin advertisement for an online video download service can dynamically include a video title in the skin layer (layer 1), and a URL of the video as a dynamic parameter to the expansion layer (layer 2). The video title and the dynamic parameter can be changed in real time, for example, in the manner detail below.

In one implementation, the InSkin player is able to change advertisement served in its skin in real time as the underlying video progresses. The video player skin (or the InSkin Advertisement Delivery Technology) can apply audio tracking technology to detect contextual keywords from the underlying video, and communicate the keywords to the advertisement serving engine 350, which in turn identifies proper customized skin and transmit back to the video player skin for display. Alternatively, the video player skin can obtain the context keywords from other sources such as the video publisher. As another example, the video can be preprocessed (e.g., by the ISAP server 110) and the advertisement serving engine 350 can proactively stream multiple InSkin advertisements to the InSkin player for display as the video progresses. Alternatively or in conjunction, the video player skin can communicate with a third party data source such as a shopping feed, banner advertisement feed, which returns data used by the video player skin to dynamically populate InSkin advertisements for display.

For example, the ISAP server 110 (or the video publisher) time codes a video clip using audio scanning technology, such that the InSkin player can determine context keywords as the video clip is played along. The customized video player skin advertises products from a merchant feed such as Shopping.com. When the InSkin player receives a new context keyword, it passes the keyword to Shopping.com (or the advertisement serving engine 350), which populates and transmits to the InSkin player template elements about related products. For example, the video player skin has the following dynamic elements on layer 1: product name, best price, and thumbnail image; and the following dynamic elements on layer 2: product name, best price, product description, user review, and a link to corresponding Shopping.com web page. When the InSkin player detects a keyword “iPod” (e.g., two actors argue over an iPod on the underlying video), the InSkin player passes the keyword to Shopping.com, retrieves skin elements related to iPod, and display them on the skin on the fly.

If for any reason a player skin is unavailable, the InSkin Advertisement Delivery Technology will not be loaded and the embedded video player will be displayed without the video player skin. Consequently, the embedded video player will display the underlying video in a normal fashion (i.e., display the video without the surrounding video player skin). In addition, the InSkin player can also play pre-roll or post-roll provided by the video publisher, the advertiser, or the online advertisement platform. A pre-roll or post-roll can be served on its own or in companion to an InSkin advertisement.

The InSkin player is deployed in a website (or site selection, web page) through the ISAP server 110. In one implementation, when a video publisher requests to integrate the InSkin Advertisement Delivery Technology in his website, the ISAP server 110 will generate a unique 16 character alpha-numeric identifier for each site selection identified by the video publisher for deployment. The ISAP server 110 then generates a link for the video publisher to download an integration kit (a.k.a., InSkin player integration tool kit) and documentation for each of the site section. The video publisher follows the documentation to use the integration kit to integrate the InSkin Advertisement Delivery Technology in each of the site sections. In one implementation, video publishers integrate the InSkin Advertisement Delivery Technology by adding embedded JavaScript code into their video web pages. The JavaScript code contains the site selection ID identifying the site selection the web page belongs to. The following two tables include example computer code for deploying the InSkin player in a website.

TABLE 1

<!-- SAS code -->
<!-- End of SAS code -->
<!-- InSkin SAS -->
<script type=“text/javascript” language=“javascript”
src=“http://88.208.248.58/~inskin/ikit/js/sas.js”></script>
<!-- End of InSkin SAS -->

TABLE 2
<!-- InSkin Player Integration Code (v 0.1) --> <script
type=“text/javascript” language=“javascript”
src=“http://88.208.248.58/~inskin/ikit/js/swfobject.js”>
</script>
<script type=“text/javascript” language=“javascript”
src=“http://88.208.248.58/~inskin/ikit/js/cjl_cookie.js”>
</script>
<script type=“text/javascript” language=“javascript”
src=“http://88.208.248.58/~inskin/ikit/js/inskin.js?v=0.1”>
</script>
<script type=“text/javascript” language=“javascript”
src=
“http://88.208.248.58/~inskin/ikit/js/inskin_wmp.js?v=0.1”>
</script>
<div id=“InSkin_player_div” style=“width: 484px; height:
474px;
position: relative; z-index: 1;”>InSkin Player is
loading...</div> <script type=“text/javascript”
language=“javascript”>
var InSkin_params = {
‘base’:
‘http://88.208.248.58/~inskin/player/’,
‘player_url’:
‘http://88.208.248.58/~inskin/player/base.swf’,
‘player_div’: ‘InSkin_player_div’,
‘player_ar’: ‘’,
‘player_w’:
‘484’,
‘player_h’:
‘474’,
‘content_w’: ‘443’,
‘content_h’: ‘380’,
‘UseSAS’:
‘true’,
‘SectionID’: ‘123321’,
‘PrerollURL’: ‘’,
‘ContentType’: ‘wmp’,
‘URL’:
‘mms://a1211.v38076a.c38076.g.vm.akamaistream.net/7/1211/38076/
v0001/hay
market.akamai1.streamuk.com/wmv/WhatCar/Mini/
Mini_Clubman_512kws.wmv’
};
var InSkin_player = new InSkinPlayer(InSkin_params);
function InSkin_SAS_loaded( ) {
InSkin_player.loadFromSAS(‘InSkin_SAS’);
InSkin_player.embed( );
}
</script>
<iframe src=“URL_TO_HTML_FILE_CREATED_ABOVE”
id=“InSkin_SAS” style=“display: none; width: 0px; height: 0px;”
width=“0” height=“0”></iframe>
<!-- End Integration Code -->

In one embodiment, the publisher creates an HTML document to include the computer code in table 1 and stores the HTML document on the web server hosting the website being deployed. The publisher copies the computer code in table 2 into his web pages in the place he wants to place the InSkin player. The string URL_TO_HTML_FILE_CREATED_ABOVE should be replaced with the actual URL of the HTML document created before the computer code is integrated into web pages. As shown, the InSkin player deployment is an easy and straightforward process.

The video player skin (or the InSkin Advertisement Delivery Technology) can extensively track all user activities and report back to the ISAP server 110. Because the InSkin player integrated in a site selection has a unique ID, the ISAP server 110 can track viewer information at the site selection level. It is noted that one skilled in the art would understand that the ISAP server 110 can assign a unique ID for individual publisher, individual website, or individual video (or web page), and thereby can track viewer activities at different granularity.

### Operation of InSkin Player

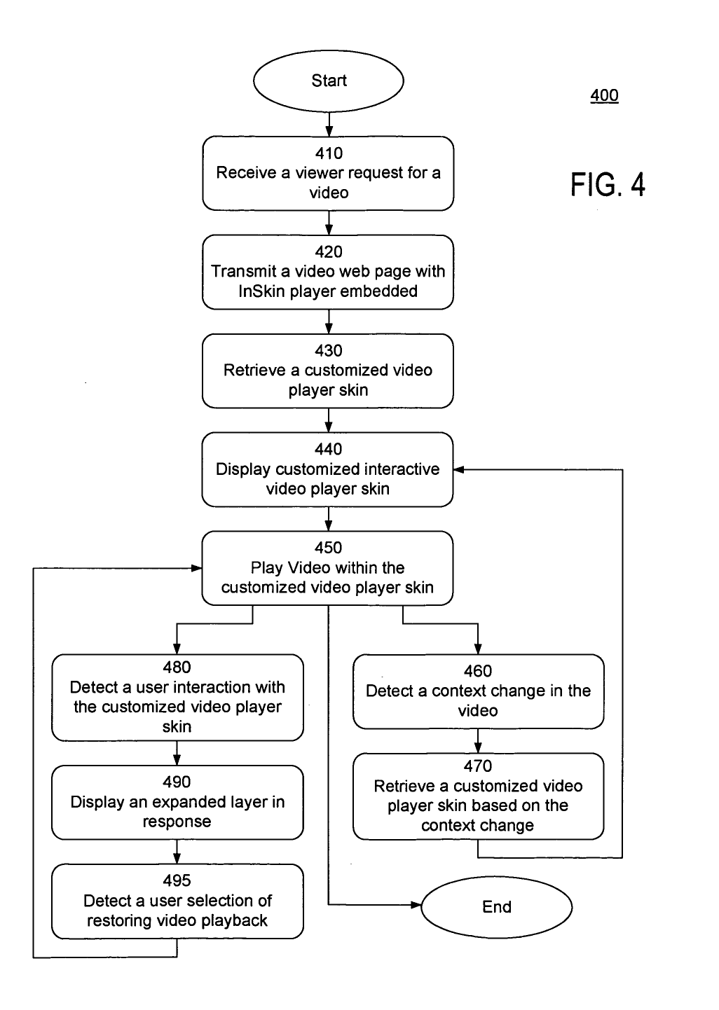

FIG. 4 is a flow diagram illustrating an example operation 400 of the InSkin player along with the integrated InSkin Advertisement Delivery Technology and the video player skin. One or more portions of the operation 400 may be implemented in embodiments of hardware and/or software or combinations thereof. For example, the operation 400 may be embodied through instructions for performing the actions described herein and such instrumentations can be stored within a tangible computer readable medium, e.g., the memory 206, and are executable by a processor, e.g., the processor 202. Furthermore, those of skill in the art will recognize that other embodiments can perform the steps of the operation 400 in different order. Moreover, other embodiments can include different and/or additional steps than the ones described here.

The operation 400 starts when a participating video publisher's website receives 410 a viewer request for a video. In response, the website transmits 420 a web page (e.g., a dynamically generated web page) including the request video. The web page has the InSkin player embedded (e.g., including a section of JavaScript code that identifies a URL of the InSkin player). The web page also includes information that identifies its affiliation (e.g., an identifier that identifies the video publisher, the website, and/or the site selection the web page belongs to). The InSkin player is loaded onto the web page by the web browser.

The InSkin player retrieves 430 a customized interactive video player skin (InSkin advertisement) and displays 440 it on the InSkin player frame. Depending on where customized video player skins are stored (e.g., the ISAP server 110, advertisers' advertisement servers), the InSkin player can request and retrieve the InSkin advertisement in one or multiple places, sequentially or in parallel. The InSkin player may provide information about the requested video in the request for InSkin advertisement. For example, the request may include an identifier that uniquely identifies the video, the site selection, the website, and/or the video publisher. The advertisement serving engine 350 can use the identifier to select a proper InSkin advertisement (e.g., an InSkin advertisement that satisfies content criteria associated with the video) and transmit to the InSkin player along with skin parameters such as the accompanying URL.

The InSkin player loads the requested video and plays 450 the video within the player skin. If no skin is retrieved 430, the InSkin player plays the video by expanding it to the full dimension of the InSkin player. In one implementation, if the publisher (or the advertiser, the ISAP server 110) provides a pre-roll, or the player skin has an accompanying pre-roll, the InSkin player plays the pre-roll before the requested video. The pre-roll may have a companion player skin, and the InSkin player will display the companion player skin while the pre-roll is played, and switch to the InSkin advertisement retrieved for the requested video when the pre-roll ends.

The InSkin player can dynamically update the InSkin advertisement served in the InSkin player frame as the underlying video progresses. When the InSkin player detects 460 a context change in the video (e.g. via keywords embedded in the video), it transmits the corresponding context keyword(s) to the advertisement serving engine 350, and retrieves 470 an InSkin advertisement that is relevant to the context keyword(s). The InSkin player displays 440 the newly retrieved InSkin advertisement in the InSkin player frame and continue plays 450 the video within the frame.

The viewer can interact with the InSkin player to control the playback (e.g., Play, Pause, Stop). In addition, the viewer can interact with the InSkin advertisement to invoke additional advertisement features. When the InSkin player detects 480 such a user interaction (e.g., the viewer clicks the InSkin player frame), it pauses the video playback and displays 490 an expanded layer (layer 2) in response. The viewer can then interact with controls on the expanded layer, or select to restore the video playback. If the InSkin player detects 495 a user selection of restoring video playback, it resumes the playback where it left off.

The InSkin player tracks user activities and lack of user activities. For example, the InSkin player tracks how long a specific InSkin advertisement is displayed to a viewer, whether the viewer clicked on the player skin, and subsequent interactions (e.g., with the expanded layer).

### Example User Experience

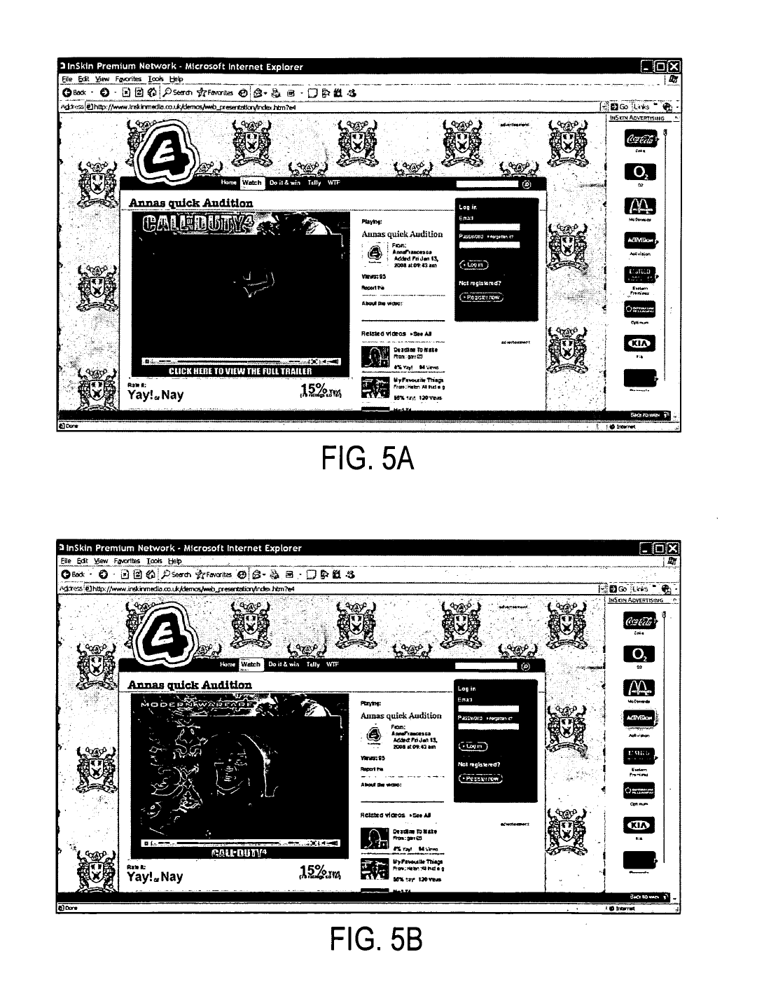

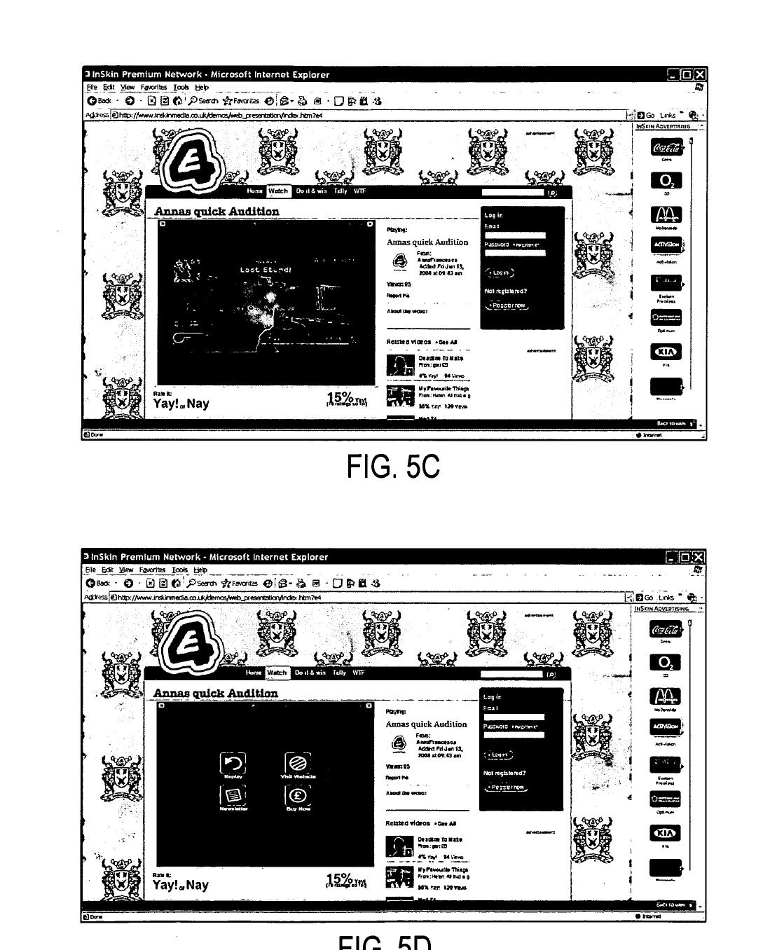

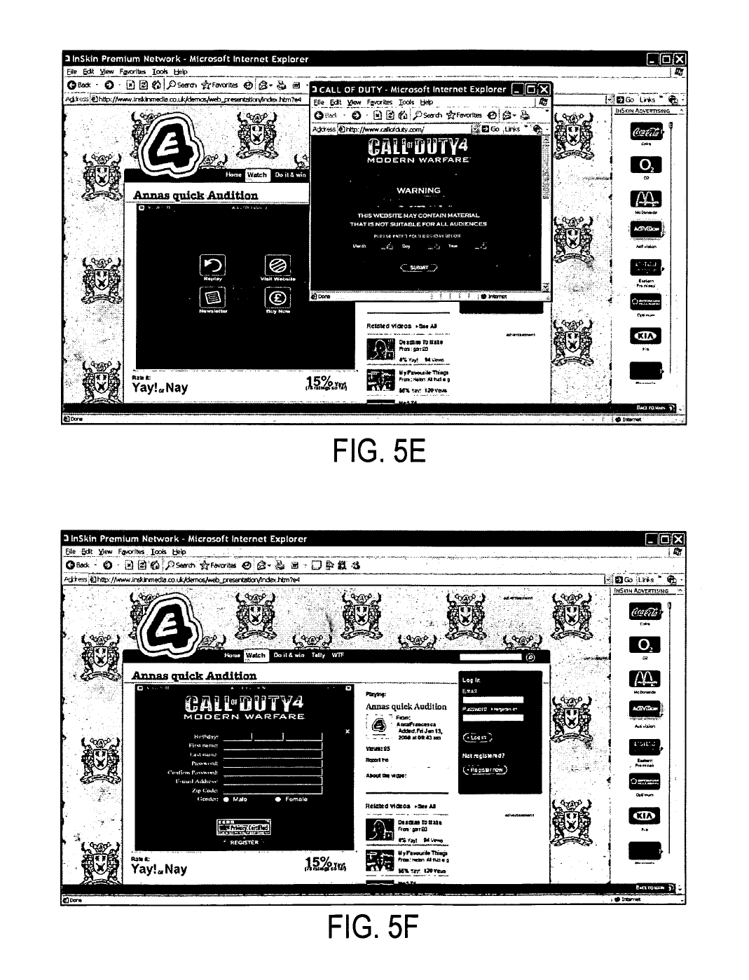

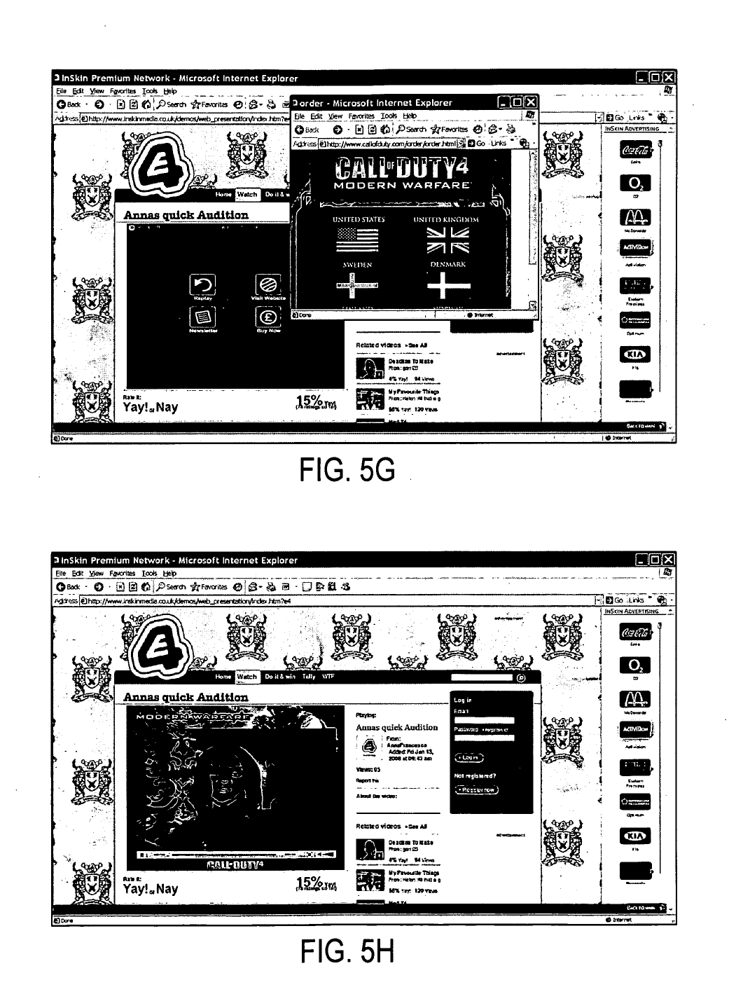

FIGS. 5A-5H are a series of user interface screenshots illustrating a process for the viewer to view a video clip using the InSkin player and interact with an InSkin advertisement. The viewer requests a video clip titled “Annas quick Audition” from a participating video publisher. A dynamic web page including the requested video clip is generated and returned to the viewer's web browser. The InSkin player is embedded in the web page. The web browser displays the web page and plays the video clip using the embedded InSkin player, as illustrated in FIG. 5A.

After the InSkin player is loaded, it requests an InSkin advertisement from the advertisement serving engine 350. The request includes information about the video (e.g., the title “Annas quick Audition”). The advertisement serving engine 350 retrieves relevant InSkin advertisements and selects one for the video game “Call of Duty 4.” The InSkin player displays the Call of Duty 4 advertisement in the InSkin player frame. As shown in FIG. 5A, the Call of Duty 4 advertisement wraps around the video clip. Displayed on top of the InSkin player frame is the name of the game, Call of Duty 4, and an image of an armed soldier. Displayed on the bottom of the InSkin player frame is a text message that reads “CLICK HERE TO VIEW THE FULL TRAILER.”

The Call of Duty 4 advertisement includes animation that changes the displayed information on the InSkin player frame. As illustrated in FIG. 5B, as the video playback progresses, the advertisement displays the game title on the bottom of the InSkin player frame, and displays the text message “MODERN WARFARE” on top.

The viewer can interact with the Call of Duty 4 advertisement. For example, the viewer can click on the InSkin player frame, and the InSkin player will pause the playback and display an expanded layer and plays a trailer of the video game on the expanded layer, as shown in FIG. 5C. When the trailer playback is over, the expanded layer can provide additional advertisement features for the viewer. As shown in FIG. 5D, the user can choose to replay the trailer, to visit the video game website, subscribe to a newsletter, or buy the video game now. In addition, the viewer can choose to view the advertisement website by clicking the left up corner of the expanded layer (“VIEW SITE”), and close the expanded layer by clicking its right up corner (“CLOSE”).

If the viewer chooses to visit the video game website by selecting the corresponding option on the expanded layer, the InSkin player will invoke another browser and direct it to the video game web page, as shown in FIG. 5E. If the viewer chooses to subscribe to the newsletter, the expanded layer will display a form for the viewer to provide user information, as shown in FIG. 5F. If the viewer chooses to purchase the video game now, the InSkin player will invoke another browser and direct it to a web page where the viewer can make the purchase, as shown in FIG. 5G.

If the viewer chooses to close the expanded layer, the InSkin player hides the expanded layer and resumes the playback where it left off, as illustrated in FIG. 5H.

### Alternative Embodiments

In one embodiment, to enhance performance, customized video player skins are stored in several servers (hereinafter called streaming servers) geographically distributed separately from the ISAP server 110. In addition, InSkin advertisements can be served through other advertisement servers or services such as the DART services (DoubleClick/Google) and ACCIPITER (Microsoft).

The ISAP server 110, the InSkin player, and InSkin advertisements are described above to place advertisements on video player skins. Alternatively or in conjunction, the InSkin player can play other media content such as audio content (e.g., music), flash, game, and static image (e.g., slide show). For example, when the InSkin player is used to display a static image, the image is contained within the InSkin player, and viewers watch InSkin advertisements served into the InSkin player frame each time a new image is displayed. Therefore, media content providers can monetize their content inventories by participating in the online advertisement platform.

In another implementation, the InSkin player can be integrated with custom built flash applications or flash widgets. In this implementation, the InSkin player is integrated with the widget or flash application. Each time the widget or flash application is viewed/activated, the InSkin player communicates with the ISAP server 110 and an InSkin advertisement is served into the InSkin player frame.

The present invention advantageously provides online media publishers with a non-intrusive advertising solution and a new revenue stream, provides advertisers with a channel to effectively reach targeted audience, and provides media viewers with an enriched viewing experience. Advertisers can purchase prime real estate in the skin of a media player and pay a specified rate based on the number of impressions delivered, the number of clicks, the number of incidences of user data capture, or the number of seconds that their advertisement was viewable within the media player skin during the playback of a video within the media player. Because the displayed advertisement can be context sensitive and interactable, it tends to be highly engaging, non-intrusive, and increases consumer impact and response. In addition, the process to integrate the technology into existing websites is also simple and straight forward.

The present invention has been described in particular detail with respect to a limited number of embodiments. One skilled in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Further, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component.

Some portions of the above description present the feature of the present invention in terms of algorithms and symbolic representations of operations on information. These algorithmic descriptions and representations are the means used by those skilled in the art to most effectively convey the substance of their work to others skilled in the art. These operations, while described functionally or logically, are understood to be implemented by computer programs. Furthermore, it has also proven convenient at times, to refer to these arrangements of operations as modules or code devices, without loss of generality.

It should be borne in mind, however, that all of these and similar terms are to be associated with the appropriate physical quantities and are merely convenient labels applied to these quantities. Unless specifically stated otherwise as apparent from the present discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the present invention include process steps and instructions described herein in the form of an algorithm. It should be noted that the process steps and instructions of the present invention could be embodied in software, firmware or hardware, and when embodied in software, could be downloaded to reside on and be operated from different platforms used by real time network operating systems.

The present invention also relates to an apparatus for performing the operations herein. This apparatus may be specially constructed for the required purposes, or it may comprise a general-purpose computer selectively activated or reconfigured by a computer program stored in the computer. Such a computer program may be stored in a computer readable storage medium, such as, but is not limited to, any type of disk including floppy disks, optical disks, CDs, DVDs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and displays presented herein are not inherently related to any particular computer or other apparatus. Various general-purpose systems may also be used with programs in accordance with the teachings herein, or it may prove convenient to construct more specialized apparatus to perform the required method steps. The required structure for a variety of these systems will appear from the description above. In addition, the present invention is not described with reference to any particular programming language. It is appreciated that a variety of programming languages may be used to implement the teachings of the present invention as described herein, and any references to specific languages are provided for disclosure of enablement and best mode of the present invention.

The figures depict preferred embodiments of the present invention for purposes of illustration only. One skilled in the art will readily recognize from the following discussion that alternative embodiments of the structures and methods illustrated herein may be employed without departing from the principles of the invention described herein.

Finally, it should be noted that the language used in the specification has been principally selected for readability and instructional purposes, and may not have been selected to delineate or circumscribe the inventive subject matter. Accordingly, the disclosure of the present invention is intended to be illustrative, but not limiting, of the scope of the invention.

I claim:

1. A computer-implemented method for delivering advertisements, the method comprising:
receiving a request from a viewer for a piece of video clip;
launching a video player for the piece of video clip;
retrieving an advertisement for the video player;
displaying the advertisement in a frame area surrounding the video player;
playing the piece of video clip in the video player; and
responsive to a user interaction with the advertisement, displaying additional information related to the advertisement.

2. The method of claim 1, further comprising:
detecting a context change in the piece of video clip as it is played in the video player; and
responsive to detecting the context change, processing:
retrieving a second advertisement related to the context change,
dynamically displaying the second advertisement in the frame area surrounding the video player, and
continue playing the piece of video clip in the video player.

3. The method of claim 2, wherein detecting comprises receiving a context keyword for the piece of video clip.

4. The method of claim 3, wherein the context keyword is generated using audio tracking technology.

5. The method of claim 1, wherein the advertisement comprises dynamic elements, and the method further comprises:
detecting a context change in the piece of video clip as it is played in the video player; and
responsive to detecting the context change, processing:
retrieving a set of dynamic element instances related to the context change, and
displaying the set of dynamic element instances in the frame area surrounding the video player.

6. The method of claim 1, wherein displaying additional information further comprises:
displaying an expanded layer on top of the video player, the expanded layer containing the additional information related to the advertisement.

7. The method of claim 6, wherein displaying the expanded layer further comprises:
pausing the playback of the piece of video clip while the expanded layer is displayed; and
resuming the playback when the expanded layer is closed.

8. The method of claim 1, further comprising:
tracking the viewer's user interactions with the advertisement; and
returning the tracked user interactions to a remote server.

9. The method of claim 1, further comprising:
tracking a duration of the advertisement being displayed to the viewer; and
returning the duration to a remote server.

10. The method of claim 1, wherein retrieving comprises:
identifying criteria related to the advertisement and criteria related to the piece of video clip; and
determining that the piece of video clip meets the criteria related to the advertisement and vice versa.

11. The method of claim 1, further comprising:
playing a pre-roll accompanying the piece advertisement by the video player before playing the piece of video clip.

12. A computer program product for delivering advertisements, the computer program product comprising a computer-readable medium containing computer program code for performing a method comprising:
receiving a request from a viewer for a piece of video clip;
launching a video player for the piece of video clip;
retrieving an advertisement for the video player;
displaying the advertisement in a frame area surrounding the video player;
playing the piece of video clip in the video player; and
responsive to a user interaction with the advertisement, displaying additional information related to the advertisement.

13. The computer program product of claim 12, wherein the method further comprises:
detecting a context change in the piece of video clip as it is played in the video player; and
responsive to detecting the context change, processing:
retrieving a second advertisement related to the context change,
dynamically displaying the second advertisement in the frame area surrounding the video player, and
continue playing the piece of video clip in the video player.

14. The computer program product of claim 13, wherein detecting comprises receiving a context keyword for the piece of video clip.

15. The computer program product of claim 14, wherein the context keyword is generated using audio tracking technology.

16. The computer program product of claim 12, wherein the advertisement comprises dynamic elements, and the method further comprises:
detecting a context change in the piece of video clip as it is played in the video player; and
responsive to detecting the context change, processing:
retrieving a set of dynamic element instances related to the context change, and
displaying the set of dynamic element instances in the frame area surrounding the video player.

17. A video player for delivering advertisements on its skin, the video player comprising:
a module for receiving a request from a viewer for a piece of video clip;
a module for launching a video player for the piece of video clip;
a module for retrieving an advertisement for the video player;
a module for displaying the advertisement in a frame area surrounding the video player;
a module for playing the piece of video clip in the video player; and
a module for displaying additional information related to the advertisement responsive to a user interaction with the advertisement.

18. The video player of claim 17, further comprising:
a module for detecting a context change in the piece of video clip as it is played in the video player; and
a module for retrieving a second advertisement related to the context change, dynamically displaying the second advertisement in the frame area surrounding the video player, and continue playing the piece of video clip in the video player responsive to detecting the context change.

19. The video player of claim 18, wherein detecting comprises receiving a context keyword for the piece of video clip.

20. The video player of claim 19, wherein the context keyword is generated using audio tracking technology.
